(19) United States
(12) Patent Application Publication
(10) Pub. No.: US 2007/0201889 A1
(43) Pub. Date: Aug. 30, 2007

(54) Image forming apparatus

(75) Inventors: Tetsuo Ishizuka, Kanagawa (JP); Osamu Uto, Kanagawa (JP); Junichirou Sameshima, Kanagawa (JP); Masato Kobayashi, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/702,227

(22) Filed: Feb. 5, 2007

(30) Foreign Application Priority Data
Feb. 27, 2006 (JP) P.2006-050379

(51) Int. Cl. G03G 15/00; G03G 15/01

(52) U.S. Cl. 399/44; 399/49; 399/301

(57) ABSTRACT

An image forming apparatus includes: an intermediate transfer element that a toner image on an image carrier is primarily transferred onto, and a multifunctional detecting unit that performs two or more functions of: detecting a first toner image on the intermediate transfer element to control a position of an image on the intermediate transfer element; detecting a second toner image on the intermediate transfer element to control a density of an image on the intermediate transfer element; and detecting an environment condition within the image forming apparatus, the multifunctional detecting unit being disposed in the vicinity of a position that the toner image is primarily transferred, and being detachable in an axial direction of the image carrier.

### CROSS-REFERENCE TO RELATED APPLICATION

This application is based on and claims priority under 35 USC §119 from Japanese Patent Application No. 2006-50379 filed Feb. 27, 2006.

### BACKGROUND

(i) Technical Field

The present invention relates to an image forming apparatus such as a photocopier and a printer which adopts the electrophotography process, and more particularly to an image forming apparatus which can enable the reduction in size and cost of a reader for reading or capturing a color registration adjustment pattern and a density adjustment pattern which are formed on an intermediate transfer element and moreover increase the reading accuracy so as to enhance reliability in maintaining image quality.

(ii) Background Art

In the background art, as an image forming apparatus, such as a photocopier and a printer, of this type which adopts the electrophotography process, for example, image forming apparatuses of so-called “4-cycle electrophotographic” type have been proposed, and some of them are now marketed as products. In such image forming apparatuses, a single light-sensitive material drum is provided to form a full color image by: sequentially imagewise exposing the single light-sensitive material drum correspondingly to colors such as yellow (Y), magenta (M), cyan (C) and black (K) so as to form electrostatic latent images of images corresponding individually to yellow (Y), magenta (M), cyan (C) and black (K) on a surface of the light-sensitive material drum; sequentially developing the electrostatic latent images of the images by corresponding developer units so as to form-toner images; primarily transferring the toner images of yellow (Y), magenta (M), cyan (C) and black (K) onto an intermediate transfer belt in an overlapped fashion; thereafter secondarily transferring those toner images from the intermediate transfer belt onto a recording paper at one time; and fixing the secondarily transferred images by a fixing unit.

In those image forming apparatuses, a reader is provided for reading or capturing a color registration adjustment pattern and a density adjustment pattern which are formed on the intermediate transfer belt, so that the color registration adjustment pattern and the density adjustment pattern are read by the reader, so as to control the image forming position and image density.

In the image forming apparatuses like this, the color registration adjustment pattern is made to be read by reader which are disposed in such positions as a near end (OUT), a central portion (CENTER) and a far end (IN) along the axial direction of the light-sensitive material drum so as to adjust color registration.

### SUMMARY

According to one aspect of the present invention, there is provided an image forming apparatus comprising:

an intermediate transfer element that a toner image on an image carrier is primarily transferred onto, and

a multifunctional detecting unit that performs two or more functions of:

detecting a first toner image on the intermediate transfer element to control a position of an image on the intermediate transfer element;

detecting a second toner image on the intermediate transfer element to control a density of an image on the intermediate transfer element; and

detecting an environment condition within the image forming apparatus,

the multifunctional detecting unit being disposed in the substantial vicinity of a position that the toner image is primarily transferred, and being detachable in an axial direction of the image carrier.

### BRIEF DESCRIPTION OF THE DRAWINGS

Embodiments of the present invention will be described in detail based on the following figures, wherein:

FIG. 1 shows a main part of a color multifunction machine of “4-cycle electrophotographic” type, which is an image forming apparatus according to exemplary Embodiment 1 of the invention;

FIG. 2 shows a main part of the color multifunction machine of “4-cycle electrophotographic” type;

FIG. 3 shows an image forming unit of the color multifunction machine of “4-cycle electrophotographic” type;

FIGS. 4A to 4D show respective sensors of the color multifunction machine of “4-cycle electrophotographic” type;

FIG. 5 shows an example of a toner image for controlling color registration;

FIG. 6 shows an example of a toner image for controlling density;

FIG. 7 shows an exemplary embodiment of a sensor which has both functions of a registration sensor and an ADC sensor;

FIG. 8 is an explanatory diagram which describes an exemplary detection principle of the sensor shown in FIG. 7;

FIG. 9 is an explanatory diagram which describes an exemplary detection principle of the sensor shown in FIG. 7; and

FIGS. 10A to 10D show respective sensors of a color multifunction machine of “4-cycle electrophotographic” type, which is an image forming apparatus according to exemplary Embodiment 2 of the invention.

### DETAILED DESCRIPTION

Exemplary embodiments of the invention will be described by reference to the accompanying drawings.

### Embodiment 1

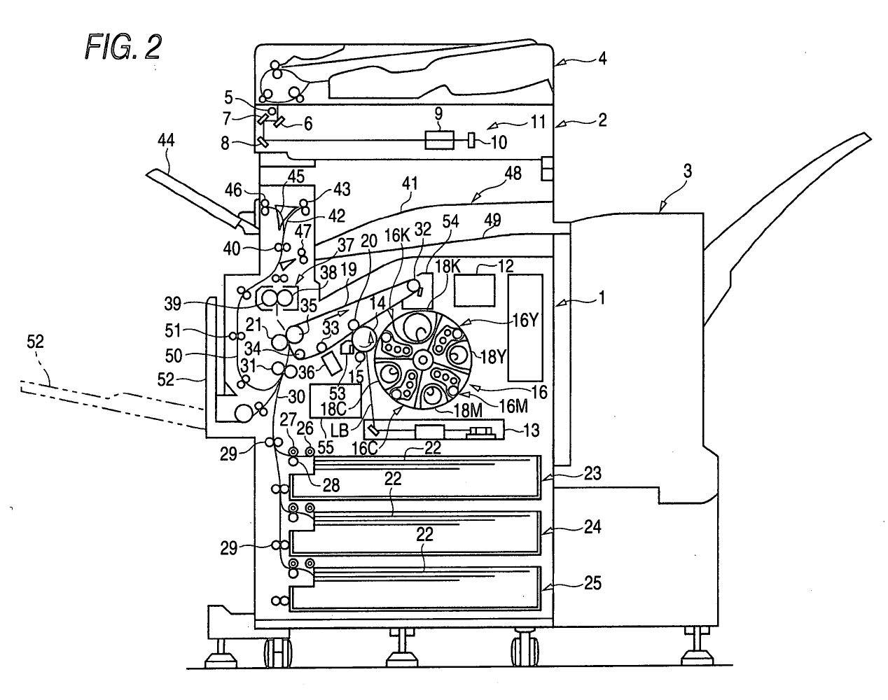

FIG. 2 is a configuration diagram showing a color multifunction machine of “4-cycle electrophotographic” type as an image forming apparatus according to exemplary Embodiment 1 of the invention. Note that this color multifunction machine is made to double as a photocopier and a printer or a facsimile machine.

As is shown in FIG. 2, this color multifunction machine includes a scanner 2 as an image reader in an upper portion of a multifunction machine main body 1 and is connected to a personal computer or the like, not shown, via a network, not shown. In addition, the color multifunction machine has a post-process operating apparatus 3 which is mounted at a right-hand side of the multifunction machine main body 1 for performing on sheets on which images are formed by the color multifunction machine post-process operations such as punching, binding and the like.

Then, the color multifunction machine is designed to function as a photocopier for making photocopies of images of texts captured by the scanner 2, a printer for making prints based on image data sent from the personal computer and a facsimile machine for sending and receiving image data via telephone lines.

In FIG. 2, reference numeral 1 denotes the main body of the color multifunction machine, and an automatic document feeder (ADF) 4 for automatically feeding documents, not shown, one by one in a separated state and the scanner 2 for capturing images on documents fed by the automatic document feeder 4 are provided in the upper portion of the color multifunction machine main body 1. Note that the automatic document feeder 4 is made to double as a platen cover. The scanner 2 is designed to read or capture a color reflected light image of a document at a dot density (for example, 16 dots/mm) with an image reader device 10 which includes a CCD or the like, in which a document placed on a glass platen, not shown, is illuminated by a light source 5, and reflected light images from the document is scanned and focused onto the image reader device via a reduction optical system 11 including a total reflecting mirror 6, a half reflecting mirrors 7, 8 and a focusing lens 9.

A reflected light image of the document which has been captured by the scanner 2 is sent to an image processing system 12 (IPS) as reflectance data in three colors such as red (R), green (G) and blue (B) (in 8 bits each color), and in this image processing system 12, an image processing is implemented, as will be described later on, which image processing includes shading correction, positional deviation correction, brightness-color space conversion, gamma correction, frame deletion, color-motion editing and the like. In addition, this image processing system 12 is made to also implement an image processing on image data that is sent from the personal computer or the like, not shown.

Then, the image data on which the image processing has been implemented at the image processing system 12 is converted into image data of four colors of yellow (Y), magenta (M), cyan (C), and black (K) (in 8 bits for each color) also by the image processing system 12 and is then sent to an ROS (Raster Output Scanner) 13 as an image exposure device. In this ROS 13 as the image exposure device, imagewise exposure is sequentially implemented by a laser beam LB according to the image data of four colors of yellow (Y), magenta (M), cyan (C), and black (K) (in 8 bits for each color). Note that in this color multifunction machine, apart from color images, only black-and-white images may, of course, be formed.

In the interior of the color multifunction machine main body 1, a light-sensitive material drum 14 as an image carrier is provided in a position lying slightly further leftwards than a central portion thereof in such a manner as to rotate along a direction indicated by an arrow. As this light-sensitive material drum 14, a drum is used which includes a conductive cylindrical body of which a surface is covered by a light-sensitive material layer such as OPC. The drum is rotated and driven along the direction indicated by the arrow at a processing speed by a driving unit, not shown.

In this color multifunction machine, the processing speed is set at, for example, about 150 mm/sec, which is relatively high in color multifunction machines of similar type, and hence, a high productivity is provided. Note that the processing speed of the color multifunction machine may of course be set to a faster speed than about 150 mm/sec when in a black-and-while mode.

The surface of the light-sensitive drum 14 is charged to an electric potential by a charging roller 15 which is disposed directly below and in the proximity of the light-sensitive material drum 14 as a charging unit, and thereafter, an imagewise exposure by means a laser beam (LB) is implemented by the ROS 13 (Raster Output Scanner) which is disposed in a position lying apart from the light-sensitive material drum 14 in an obliquely downward direction as the image exposure device, an electrostatic latent image being thereby formed according to the image data. In the ROS 13, imagewise exposure is sequentially implemented based on image data corresponding to the respective colors of for example yellow (Y), magenta (M), cyan (C), and black (K) (in 8 bits for each color). The electrostatic latent images formed on the light-sensitive material drum 14 are developed by a rotary developing device 16 in which developer units 16Y, 16M, 16C, 16K which correspond to the respective colors of yellow (Y), magenta (M), cyan (C), and black (K) are disposed along a circumferential direction thereof to thereby constitute toner images of corresponding colors.

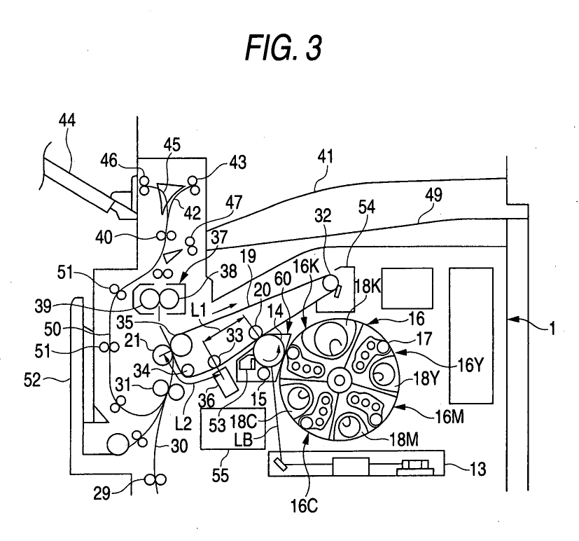

As is shown in FIGS. 2 and 3, in the rotary developing device 16, the four yellow (Y), magenta (M), cyan (C) and black (K) developer units 16Y, 16M, 16C, 16K are mounted at intervals of an angle along a circumferential direction of a rotary frame which rotates about a rotational axis. In addition, the four yellow (Y), magenta (M), cyan (C) and black (K) developer units 16Y, 16M, 16C, 16K are configured such that developing rollers 17 provided in respective openings in the developer units 16Y, 16M, 16C, 16K are stopped in a developing position which faces the light-sensitive material drum 14 by detecting and controlling rotating positions of the rotary frame by positions of slits (not shown) provided on the rotary frame so as to develop the electrostatic latent images formed on the light-sensitive material drum 14 by toners of corresponding colors.

Furthermore, toner cartridges 18Y, 18M, 18C, 18K are individually mounted on the developer units 16Y, 16M, 16C, 16K in such a manner as to be adjacent to the developer units 16Y, 16M, 16C, 16K, respectively, and toners in corresponding colors are supplied from the toner cartridges 18Y, 18M, 18C, 18K to the corresponding developer units 16Y, 16M, 16C, 16K at timings so as to adjust individually toner densities in the developer units 16Y, 16M, 16C, 16K.

In this embodiment, as is shown in FIGS. 2 and 3, among the four toner cartridges 18Y, 18M, 18C, 18K which contains yellow (Y), magenta (M), cyan (C), and black (K) toners, respectively, the toner cartridge 18K containing black (K) toner which is consumed most is formed larger than the other toner cartridges 18Y, 18M, 18(C), so that a large amount of black (K) toner can be stored in the black toner cartridge 18(K).

Charging, exposing and developing processes are repeatedly implemented certain times on the surface of the light-sensitive material drum 14 according to colors of images to be formed thereon. In the rotary developing device 16, the developing rollers 17 of the developer units 16Y, 16M, 16C, 16K are moved to their developing positions which face the light-sensitive material drum 14 according to colors in which images are formed. For example, in the case of forming a full-color image, the charging, exposing and developing processes are performed four times correspondingly to the individual colors of yellow (Y), magenta (M), cyan (C) and black (K), and toner images corresponding individually to yellow (Y), magenta (M), cyan (C) and black (K) are sequentially formed on the surface of the light-sensitive material drum 14.

In addition, in the case of forming a monochrome image, the charging, exposing and developing processes are implemented only once on the surface of the light-sensitive drum 14 correspondingly to the color of black (K), and only a toner image corresponding to the black (K) color is formed on the surface of the light-sensitive material drum 14.

The toner images of yellow (Y), magenta (M), cyan (C) and black (K) which are formed sequentially on the light-sensitive material drum 14 are primarily transferred onto an intermediate transfer belt 19, which is an intermediate transfer element, by a primary transfer roller 20 in such a state that the toner images are superposed on each other in a primary transfer position where the intermediate transfer belt 19 is brought into abutment with an outer circumference of the light-sensitive material drum 14. In addition, in the case of forming a monochrome image, a black (K) toner image is primarily transferred on the surface of the light-sensitive material drum 14 only once by the primary transfer roller 20.

The toner images of yellow (Y), magenta (M), cyan (C) and black (K) which are transferred onto the intermediate transfer belt 19 in the superposed fashion are secondarily transferred at one time on to a recording sheet 22 as a recording medium which is fed at a timing by a secondary transfer roller 21 in a secondary transfer position.

Recording sheets 22 having certain sizes and qualities are fed one by one in a separated fashion from any of feeder trays 23, 24, 25, which are provided in a plurality of stages in a lower portion of the color multifunction machine main body 1, by a feed roller 26, a separation roller 27 and a retarder roller 28 via a sheet feeding path 30 provided with transfer rollers 29. Then, a recording sheet 22 fed from any of the feeder trays 23, 24, 25 is temporarily stopped by register rollers 31 and then fed to the secondary transfer position of the intermediate transfer belt 19 by the register rollers 31 in synchronism with the images on the intermediate transfer belt 19. Note that when secondarily transferring the toner images from the intermediate transfer belt 19 onto the recording sheet 22, there may occur a case where toner as a developer, certain substances externally adhering to toner and the like adhere to and remain on the intermediate transfer belt 19.

As is shown in FIGS. 2 and 3, the intermediate transfer belt 19 is made to be extended over a plurality of rollers under tension, be brought into abutment with the surface of the light-sensitive material drum 14 in the primary transfer position and be rotated and driven at a processing speed (about 150 mm/sec). The intermediate transfer belt 19 is formed from, for example, a synthetic resin such as a polyimide resin into an endless belt shape. This intermediate transfer belt 19 is stretched at a tension by a drive roller 32, the primary transfer roller 20 which primarily transfers toner images formed on the light-sensitive material drum 14 onto the intermediate transfer roller 19, a sensor roller 33, a tension adjustment roller 34 and a backup roller 35 which is brought into abutment with the secondary transfer roller 21 via the intermediate transfer belt 19.

In addition, although the intermediate transfer belt 19 is stretched by the plurality of rollers 20, 32 to 34 as has been described above, in this embodiment, in order to realize the reduction in size of the color multifunction machine, the intermediate transfer belt 19 is designed to be extended and stretched in a flat, elongated isosceles triangle shape in cross section or viewed from the side.

Furthermore, as will be described later on, a multifunction sensor 36, which is a multifunctional detecting unit, is provided in a position which faces the sensor roller 33 of the intermediate transfer belt 19.

In addition, as is shown in FIGS. 2 and 3, the recording sheet 2 onto which the toner images of the relevant colors are transferred is subjected to a fixing process through heat and pressure by a heating roller 38 and a pressurizing belt (or a pressurizing roller) 39 in a fixing unit 37 and is then fed by feeding rollers 40 to a primary sheet feeding path 42 for discharging a sheet with its image formed surface down onto a face down tray 41 as a primary discharge tray which is provided in the upper portion of the multifunction machine main body 1 so as to thereafter be discharged onto the face down tray 41 by discharge rollers 43 provided at an exit of the sheet feeding path 42.

In addition, in the event that the recoding sheet 22 on which the images are formed is discharged with its image formed face up, the recording sheet 22 is, as is shown in FIG. 2, discharged with its image formed surface up onto a face up tray 44 as a secondary discharge tray which is provided on a side portion (a left-hand side surface in the figure) of the multifunction machine main body 1 via secondary sheet feeding path 45 for discharging a sheet onto the face up tray 45 by discharge rollers 46 provided at an exit of the secondary sheet feeding path 45.

In addition, as has been described before, the post-process operating apparatus 3 is mounted on the right-hand side surface of the color multifunction machine main body 1, and when post-process operations such as punching and binding are implemented on recording sheets 22 on which images are formed by the color multifunction machine, recording sheets 22 on which toner images have been fixed by the fixing unit 37 are designed to be discharged by discharge rollers 47 so as to be fed to the post-process operating apparatus 3 via a sheet feeding path 49 which is provided in the interior of a feeder unit 48 which includes the face down tray 41, whereby the post-process operations are implemented on the recording sheets 22 so fed by the post-process operating apparatus 3.

Additionally, a full-color dual-side photocopying is made in the color multifunction machine, as is shown in FIG. 2, a recording sheet 22 which has images fixed on one side thereof is not discharge directly on to the face down tray 41 by the discharge rollers 43 but is guided to the discharge rollers 47 by switching feeding directions by a switching gate, whereby while a rear end of the recording sheet 22 is held between the discharge rollers 47, the discharge rollers 47 are temporarily stopped and thereafter are rotated reversely, so that the recording sheet 22 is fed to a dual-side photocopying sheet feeding path 50 by the discharge rollers 47. Then, in this dual-side photocopying sheet feeding path 50, the recording sheet 22 is fed back to the register rollers 31 by feeding rollers 51 which are provided along the relevant feeding path 50 in such a state that front and back sides of the recording sheet 22 are reversed. Then, this time, images are transferred onto and fixed on the back side of the recording sheet 22, and thereafter, the recording sheet 22 is discharged on to either of the face down tray 41 and the face up tray 44 via the primary sheet feeding path 42 or the secondary sheet feeding path 45.

In FIG. 2, reference numeral 52 denotes a manual feeder tray for feeding a desired recording sheet 22, 53 a cleaning device for cleaning the surface of the light-sensitive material drum 14, 54 a cleaning device for cleaning the surface of the intermediate transfer belt 19, and 55 a recovery box for recovering the toners removed by the cleaning device 54.

Note that the cleaning device 54 is designed to be kept apart from the surface of the intermediate transfer belt 19 until a toner image of the final color has passed therethrough and be brought into abutment of the surface of the intermediate transfer belt 19 after the toner image of the final color has passed therethrough.

Incidentally, in this embodiment, the image forming apparatus is designed as an image forming apparatus for forming an image by primarily transferring a toner image formed on an image carrier onto an intermediate transfer element, thereafter, secondarily transferring the toner image on the intermediate transfer element onto a recording medium, and fixing the secondarily transferred image, including:

at least one multifunctional detecting unit disposed in the vicinity of a position where the primary transferring is performed and in such a manner as to be detachable in an axial direction of the image carrier, the at least one multifunctional detecting unit performing two or more functions of:

detecting an image position-controlling toner image (a first toner image) on the intermediate transfer element to control a position of an image on the intermediate transfer element;

detecting an image density-controlling toner image (a second toner image) on the intermediate transfer element to control a density of an image on the intermediate transfer element; and

detecting an environment condition within the image forming apparatus.

In addition, in this embodiment, the image forming apparatus is designed such that the at least one multifunctional detecting unit is one multifunctional detecting unit, and the one multifunctional detecting unit is fixedly disposed in a position after the one multifunctional detecting unit is moved in the axial direction of the image carrier to detect and adjust two or more of the image position-controlling toner image on the intermediate transfer element, the image density controlling-toner image on the intermediate transfer element and the environment condition.

Namely, in this embodiment, as is shown in FIGS. 2 and 3, the multifunction sensor 36, which is the multifunctional detecting unit, is provided in a position which faces a location on the surface of the intermediate transfer belt 19 which is tensioned by the sensor roller 33. This multifunction sensor 36 is designed to perform two or more functions of the image position detecting unit for detecting the color registration-controlling toner image (the image position-controlling toner image) formed on the intermediate transfer belt 19, the image density detecting unit for detecting the image density-controlling toner image formed on the intermediate transfer belt 19 and the environment detecting unit for detecting an environmental condition within the image forming apparatus main body, and in this embodiment, the multifunction sensor 36 is provided with the three functions of the image position detecting unit, the image density detecting unit and the environment detecting unit.

However, the multifunction sensor 36 does not have to have all of the three functions of the image position detecting unit, the image density detecting unit and the environment detecting unit and hence may be configured so as to have only two functions of the three functions; for example, the function of the image density detecting unit and the function of the environment detecting unit or the function of the image density detecting unit and the function of the image position detecting unit.

In addition, as is shown in FIG. 3, the multifunction sensor 36 is set such that a distance L1 between a position where the multifunction sensor 36 is disposed and the position of the primary transfer position (where the primarily transferring is performed) is equal to or less than a distance L2 between the position where the multifunction sensor 36 is disposed and the secondary transfer position (where the secondarily transferring is performed), and moreover, the multifunction sensor 36 is provided relatively near to the image forming position, that is, the primary transfer position of the light-sensitive material drum 14.

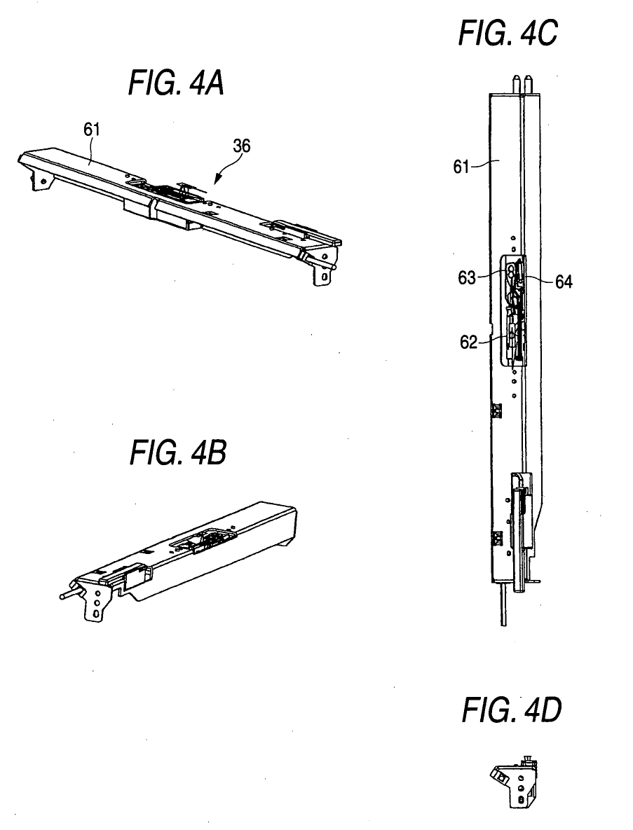

As is shown in FIGS. 4A to 4D, the multifunction sensor 36 has a sensor main body 61 which is formed into an elongated rectangular shape, and a registration sensor 62 as the image position detecting unit, an ADC sensor 63 as the image density detecting unit and an environment sensor 64 as the environment detecting sensor for detecting temperature and humidity are integrally mounted at a substantially central portion of the sensor main body 61.

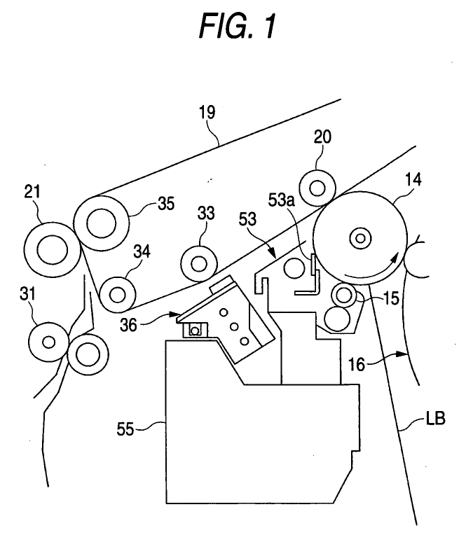

In addition, as is shown in FIG. 1, the sensor main body of the multifunction sensor 36 is mounted in a position on the color multifunction machine main body 1 in such a manner as to be detachable along an axial direction of the light-sensitive material drum 14 (a normal direction to the figure), that is, in a direction at right angles to the traveling direction of the intermediate transfer belt 19 (a width direction), so that the multifunction sensor 36 is moved to arbitrary positions along the axial direction of the light-sensitive material drum 14, for example, a near end (OUT), a central portion (CENTER) and a far end (IN), respectively, so as to detect the color registration-controlling toner image and the image density-controlling toner images which are formed on the intermediate transfer belt 19.

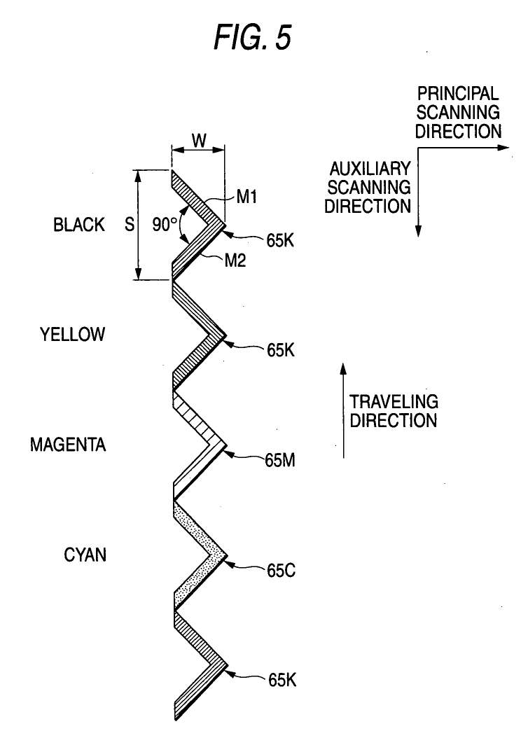

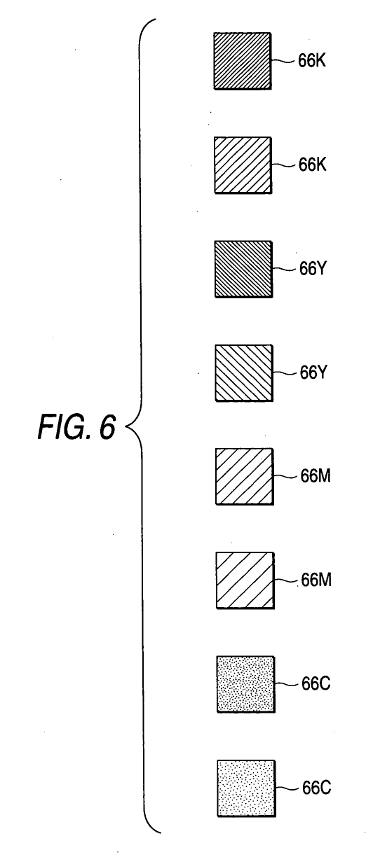

As the color registration-controlling toner image 65, for example, a pattern (including 65K, 65Y, 65M, 65C) shown in FIG. 5 is used. In addition, as the image density-controlling toner image (toner patch) 66, for example, a pattern (including 66K, 66Y, 66M, 66C) shown in FIG. 6 is used.

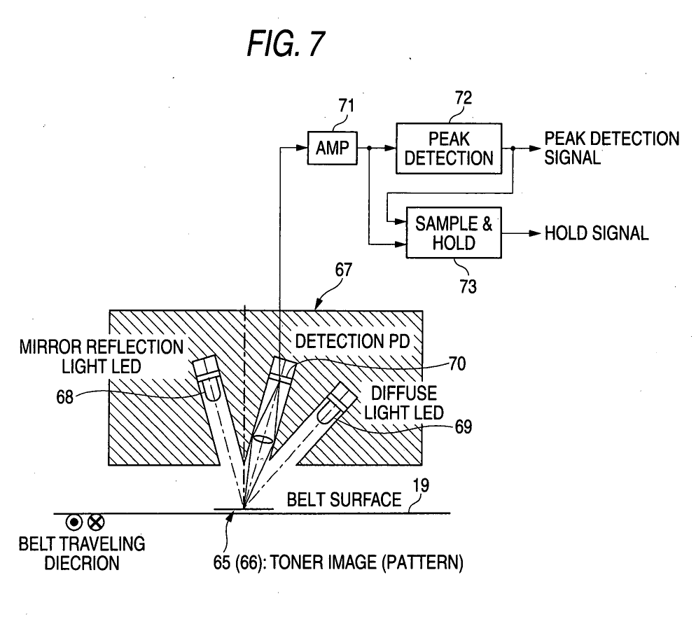

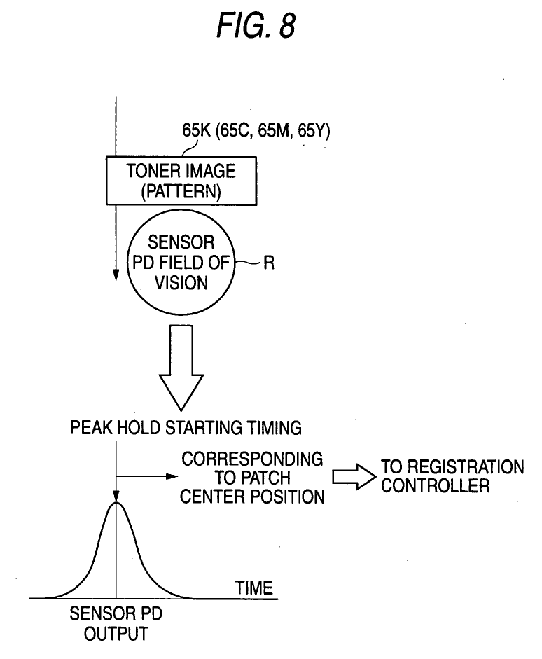

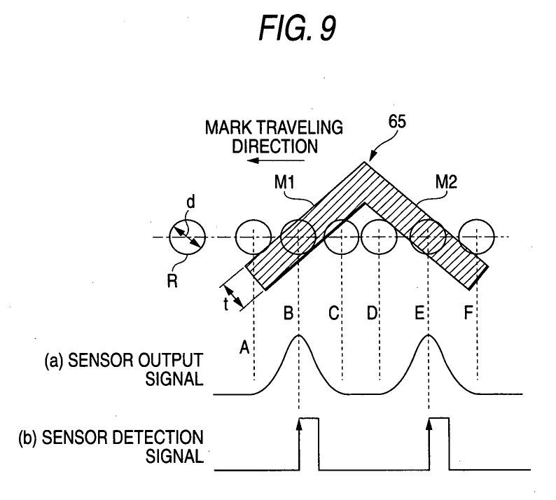

As the registration sensor 62 and the ADC sensor 63 for detecting the color registration-controlling toner image 65 and the image density-controlling toner image 66, for example, a sensor shown in FIG. 7 is used in which the functions of the registration sensor 62 and the ADC sensor 63 are combined together. The sensor 67 which has the functions of the registration sensor 62 and the ADC sensor 63 combined together includes a mirror reflection light LED 68, a diffuse light LED 69 and a detection photodiode 70 so as to detect the position of the color registration-controlling toner image 65 and the density of the image density-controlling toner image 66 as is shown in FIGS. 8 and 9 by amplifying an output of the detection photodiode 70 by an amplifier 71 and outputting a peak signal and a hold signal by a peak detection circuit 72 and a sampling and hold circuit 73.

In addition, as the environment sensor 64, although a sensor is used which detects both temperature and humidity, a sensor may be used which detects only either temperature or humidity, for example, only humidity.

In the color multifunction machine according to the embodiment, as is shown in FIGS. 5 and 6, for example, when it is shipped from the factory or after a number of prints are made, a color registration-controlling toner image 65 and an image density-controlling toner image 66 are formed at the near end (OUT), the central portion (CENTER) and the far end (IN), respectively, along the width direction of the intermediate transfer belt 19, whereby the color registration-controlling toner images 65 and the image density-controlling toner images 66 so formed are then detected by the multifunction sensor 36, and temperature and humidity in the vicinity of the image forming portion inside the color multifunction machine main body 1 are detected.

As this occurs, as is shown in FIG. 7, since the sensor for detecting both the color registration-controlling toner image 65 and the image density-controlling toner 66 and the environment sensor 64 are provide only one for each, when detecting the color registration controlling toner images 65 and the image density controlling toner images 66 which are formed at the near end (OUT), the central portion (CENTER) and the far end (IN) along the width direction of the intermediate transfer belt 19, the multifunction sensor 36 is designed to be firstly moved to the near end (OUT), the central portion (CENTER) and the far end (IN) for detection.

Note that temperature and humidity may be designed to be detected at three locations at the near end (OUT), the central portion (CENTER) and the far end (IN) so as to take an average value thereof.

Then, after the multifunction sensor 36 has detected the color registration-controlling toner images 65 and the image density-controlling toner images 66 which are formed at the near end (OUT), the central portion (CENTER) and the far end (IN), respectively, along the width direction of the intermediate transfer belt 19, controlling operations of color registration and image density are implemented, whereafter the multifunction sensor is moved to, for example, the central portion (CENTER) so as to be disposed in a fixed state for shipment of the color multifunction machine.

The reason the multifunction sensor 36 is finally disposed at the central portion (CENTER) is that ribs are provided at both end portions of the intermediate transfer belt 19 in the width direction thereof, so as to provide a construction in which a walk phenomenon of the intermediate transfer belt portion 19 is made difficult to be produced, whereby a sufficient image quality can be maintained only through color registration at the central portion (CENTER) after the shipment of the color multifunction machine.

In addition, if any major change in color registration after the use of the color multifunction machine by a user, the color registration is designed to be adjusted again by a service engineer.

### Embodiment 2

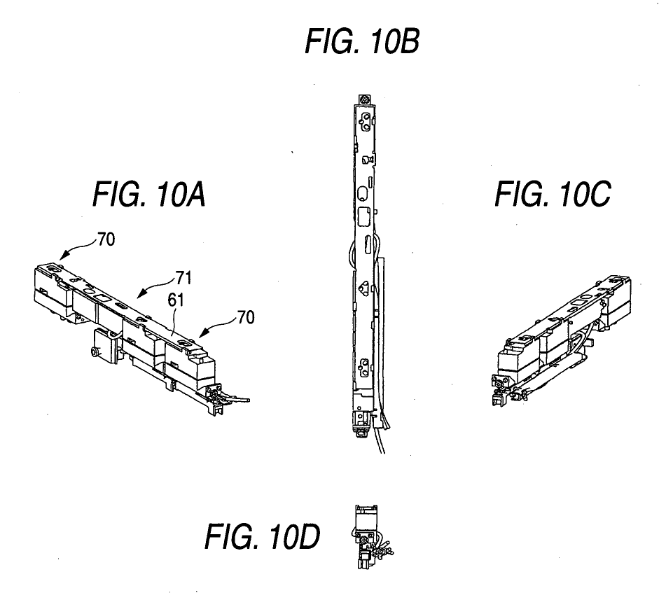

FIGS. 10A to 10D are such as to show exemplary Embodiment 2 of the invention. To describe this embodiment with like reference numerals given to like portions to those described in Embodiment 1, in this embodiment, basically three multifunctional detecting units are provided, whereby multifunctional detecting units disposed at both end portions of an intermediate transfer belt 19 along a width direction thereof are made to detect image density and an environmental condition, and a multifunctional detecting unit at the center is made to detect color registration and image density, and all environmental conditions.

Namely, in Embodiment 2, as is shown in FIGS. 10A to 10D, a main body of the multifunction sensor 36 is formed long over the overall width of the intermediate transfer belt 19, and sensors 70 for detecting image density and an environmental condition are provided at both end portions of the sensor main body 61, and a sensor 71 is disposed at the center for detecting color registration and image density, and all environmental conditions.

Note that the sensor 71 at the center may be such as to detect only color registration and image density.

Since the other configurations and functions are similar to those of Embodiment 1, the description thereof will be omitted.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an intermediate transfer element that a toner image on an image carrier is primarily transferred onto, and
a multifunctional detecting unit that performs two or more functions of:
detecting a first toner image on the intermediate transfer element to control a position of an image on the intermediate transfer element;
detecting a second toner image on the intermediate transfer element to control a density of an image on the intermediate transfer element; and
detecting an environment condition within the image forming apparatus,
the multifunctional detecting unit being disposed in the substantial vicinity of a position that the toner image is primarily transferred, and being detachable in an axial direction of the image carrier.

2. The image forming apparatus according to claim 1, wherein the multifunctional detecting unit is fixedly disposed in a position after the multifunctional detecting unit is moved in the axial direction of the image carrier to detect and adjust two or more of the first toner image, the second toner image and the environment condition.

3. The image forming apparatus according to claim 1, comprising a plurality of multifunctional detecting units,
a first multifunctional detecting unit being fixedly disposed in a position,
a second multifunctional detecting unit being fixedly disposed in a position after the second multifunctional detecting unit is moved in the axial direction of the image carrier to detect and adjust two or more of the first toner image, the second toner image and the environment condition.

4. The image forming apparatus according to claim 1, wherein the toner image primarily transferred onto the intermediate transfer element is secondary transferred onto a recording medium, and a first distance between the position that the multifunctional detecting unit is fixed and the position that the toner image is primarily transferred is equal to or less than a second distance between the position that the multifunctional detecting unit is fixed and the position that the toner image is secondarily transferred along a direction of movement of the intermediate transfer element.

5. An image forming apparatus comprising:
an intermediate transfer element that a toner image on an image carrier is primarily transferred onto and secondary transfers the toner image to a recording medium,
a fixing unit that fixes the toner image on the recording medium, the fixing unit being disposed above the intermediate transfer element, and
a multifunctional detecting unit that performs two or more functions of:
detecting a first toner image on the intermediate transfer element to control a position of an image on the intermediate transfer element;
detecting a second toner image on the intermediate transfer element to control a density of an image on the intermediate transfer element; and
detecting an environment condition within the image forming apparatus,
the multifunctional detecting unit being disposed below the intermediate transfer element, and being detachable in an axial direction of the image carrier.

6. An image forming method comprising:
primarily transferring a toner image on an image carrier onto an intermediate transfer element, and
detecting two or more of:
a first toner image on the intermediate transfer element to control a position of an image on the intermediate transfer element;
a second toner image on the intermediate transfer element to control a density of an image on the intermediate transfer element; and
an environment condition within the image forming apparatus,
the detecting being performed in the substantial vicinity of a position that the toner image is primarily transferred.

7. An image forming method comprising:
primarily transferring a toner image on an image carrier onto an intermediate transfer element,
secondary transferring the toner image to a recording medium,
fixing the toner image on the recording medium above the intermediate transfer element, and
detecting two or more of:
a first toner image on the intermediate transfer element to control a position of an image on the intermediate transfer element;
a second toner image on the intermediate transfer element to control a density of an image on the intermediate transfer element; and
an environment condition within the image forming apparatus,
the detecting being performed below the intermediate transfer element.
